(19) United States
(12) Patent Application Publication
(10) Pub. No.: US 2004/0192252 A1
(43) Pub. Date: Sep. 30, 2004

(54) Emergency packet data network communication system and call features

(76) Inventors: Naveen Aerrabotu, Gurnee, IL (US); Mark E. Pecen, Palatine, IL (US); Yilin Zhao, Northbrook, IL (US)

Correspondence Address: MOTOROLA, INC., 1303 EAST ALGONQUIN ROAD, IL01/3RD, SCHAUMBURG, IL, 60196

(21) Appl. No.: 10/403,904

(22) Filed: Mar. 31, 2003

(51) Int. Cl. H04Q 7/20

(52) U.S. Cl. 455/404.1; 455/466; 455/552.1; 455/445

(57) ABSTRACT

A method and apparatus for providing callback from a called party to an anonymous initiating user device after a dropped call in a packet data network communication system includes a first step of initiating a call from the user device on an originating network. A next step includes detecting a missing identity of the user device. A next step includes assigning an interim identity to the user device. A next step includes routing the call with the associated interim identity to the called party. A next step includes disconnecting of the call, with the user device roaming to a new network. A next step includes attaching of the user device on the new network with PDP context activation. A next step includes providing the interim identity of the user device and an originating network identity to the new network. A next step includes forwarding a callback of the called party from the originating network to the new network to the user device camped on the new network using the information from the providing step.

### FIELD OF THE INVENTION

The present invention relates generally to wireless communications, and in particular, the present invention relates to generation of a callback to an initiating radiotelephone without a valid identity in a packet data network.

### BACKGROUND OF THE INVENTION

In telecommunications systems, a mobile device includes hardware and software specific to a radio interface, along with subscriber specific data located in an identity module. For example, the Global System for Mobile Communications (GSM) system uses a subscriber identity module (SIM). The Universal Mobile Telephone Service (UMTS) or WCDMA, which is a third generation wireless network standard enhancing GSM, uses a Universal SIM (USIM). And the cdma2000 or cdmaOne system uses a Removable User Identity Module (R-UIM), which can all generally be referred to as SIM. In UMTS specifications, the term of universal integrated circuit card (UICC) is used. UICC is a physically secure device, an IC card (or ‘smart card’), that can be inserted and removed from the terminal equipment. It may contain one or more applications. One of the applications may be a USIM. The SIM can either be a smart card having physical dimensions similar to the well-known size of credit cards, or alternately can be “cut” to a much smaller format, commonly referred to as a ‘plug-in SIM”. In either case, the SIM card contains and organizes information, such as identity information identifying the subscriber as a valid subscriber, subscriber supplied information, such as telephone numbers, for example, operator specific information, and a certain subset of mobility management state information, such as information about the last public land mobile network (PLMN) in which the mobile device was registered.

Normally, without an identity module in place, a call will not be accepted on a communication network. However, the Federal Communication Commission has mandated that phone without an identity module, or even a phone number, must be able to place emergency calls in a communication system. Moreover, a receiving call center must have the ability to callback the initiating device if a call is dropped in order to confirm that the emergency call was legitimately placed, for resuming a suddenly dropped call, or for security reasons within the FCC mandated callback time which is usually forty-five minutes. This raises problems of how to contact a device without an identity. This problem is compounded in packet-switched network where individual packets must be addressed properly. Further, if a call was dropped because a device is roaming in a network or moved to a different network after the call ended or dropped, then it would be difficult to address the anonymous device. This is because the IP address cannot be resolved and packets cannot be forwarded when the mobile moves to a different network. The problem is exacerbated between those networks without a roaming agreement.

Techniques have recently become available for a mobile subscriber, either on GSM General Packet Radio Service (GPRS) and Enhanced Data for Global Evolution (EDGE), or on UMTS, to place an anonymous call, such as an emergency call, in either a circuit-switched or a packet-switched data domain without a SIM card. However, these techniques do not address the case where a call is dropped due to roaming.

Accordingly, what is needed is a method and apparatus for enabling the connection and callback of anonymous user device that is roaming in a packet-switched data domain.

### BRIEF DESCRIPTION OF THE DRAWINGS

The features of the present invention, which are believed to be novel, are set forth with particularity in the appended claims. The invention, together with further objects and advantages thereof, may best be understood by making reference to the following description, taken in conjunction with the accompanying drawings, in the several figures of which like reference numerals identify identical elements, and wherein:

FIG. 1 shows a simplified example of an anonymous mobile unit and roaming networks, in accordance with the present invention;

FIG. 2 illustrates the interaction between a mobile unit and a network, in accordance with the present invention; and

FIG. 3 illustrates a flow chart of method of anonymous operation, in accordance with the present invention.

### DETAILED DESCRIPTION OF THE PREFERRED EMBODIMENT

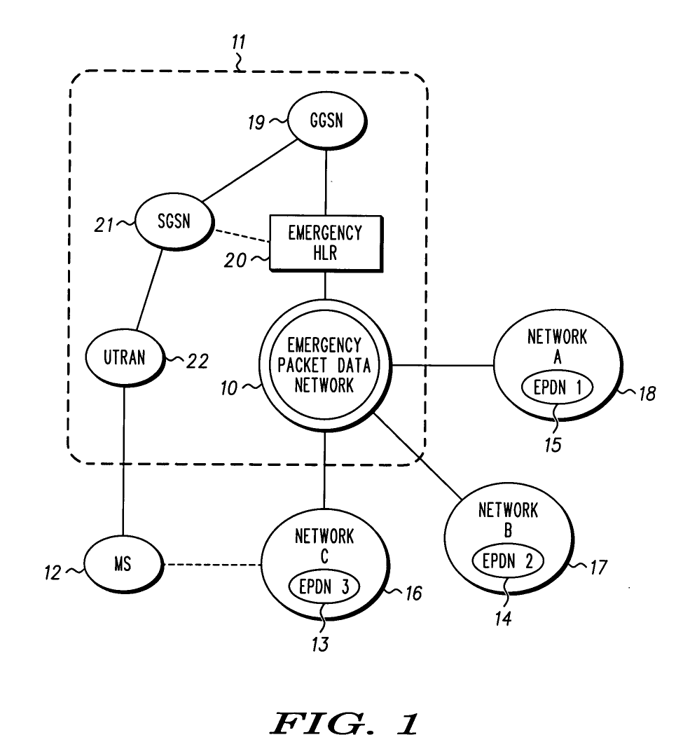

The present invention provides a method and apparatus for enabling the connection and callback of anonymous user device that is roaming across networks in a packet-switched data domain, such as E911 emergency service for example. The problems and issues seen with anonymous access are resolved in the present invention through the use of an Emergency Packet Data Network (E-PDN) associated with each public land mobile network (PLMN), as shown in FIG. 1. The E-PDN 10 of the network 11 allows the callback to a user device 12, such as a mobile station (MS) radiotelephone when a call is dropped, even when the device is roaming between networks. This is of particular importance where there are no roaming agreements between the networks being roamed since identity (i.e. IP address) of the MS is not be maintained when a call is dropped. The present invention maintains address integrity because an E-PDN 10,13,14,15 is associated with each respective network 11,16,17,18, and all the E-PDN are commonly linked to each other. Therefore, any IP addresses ambiguity of packet data of an anonymous caller can be resolved between the E-PDN of the networks. The E-PDN also allows the service provider to isolate the Emergency Traffic from the normal traffic, and provides flexibility for effective monitoring. The service providers can route this traffic, if needed, with dedicated network entities.

In the following description, GPRS/UMTS is used as an example for detailed description. It should be obvious to those skilled in the art that the methods and apparatuses discussed are applicable or can be easily extended to other third or later generation telecommunication systems. The present invention enables callback access to an anonymous caller (i.e. with the absence of a subscriber identity module (SIM) card) with a minimal impact on the existing standardized signaling protocol. An emergency or interim international mobile subscriber identity (IMSI) is generated in response to the SIM card not being positioned within the mobile user device so that the interim IMSI is utilized for signaling exchanges requiring information corresponding to the SIM card when the SIM card is not inserted within the mobile user device. This functionality is facilitated by the E-PDN.

It is envisioned that the Emergency Packet Data Network 10 is incorporated within each PLMN 11. For example, the E-PDN 10 can be included within a Server GPRS Service Node (SGSN) 21 or preferably a Gateway GPRS Service Node (GGSN) 19 of the network 11. However, the E-PDN can be contained within other location such as an Emergency Home Location Register (HLR) 20 as described in WO 02/080499, “Method and Apparatus for Anonymous Network Access in the Absence of a Mobile Subscriber Identity Module”, by Pecen et al., herein incorporated by reference.

The Emergency Packet Data Network 10 implements a set of IP addresses than can be resolved between E-PDNs 10,13 when a mobile 12 roams from one network 11 to another network 16. A mobile upon moving to a new network gets a new IP address upon PDP context activation. This new IP address, Interim Identity/IMEI, and old PLMN information is used by the new network to communicate to the old network and generate a mapping of the two IP addresses (old/new) or through a location update process so that packets can be forwarded to the serving network. This update process is needed if mobile did a PDP context activation, which could be a case where the user moved from an emergency attach state to a full attach state or vice versa. A mobile upon entering a new network after attaching to the network can pass the information to the new network of its old IP address and the old PLMN. The new network can in-turn update the old network with the new serving PLMN. Thereafter, packets destined to the old network will get forwarded to new SGSN or new network. This technique works in a case where the mobile does not get an IP address but stays attached in the new network. By providing the old IP address the new network can find the old network with or without PLMN information through IP address resolution. The combination of old IP plus the unique mobile identity will ensure routing of the packets to the new network. The IP address mapping or a routing area update for the anonymous user should be deleted on the initiating network after the FCC mandated time. Preferably, the mobile runs a timer that starts at the end of an emergency call and lasts for a FCC-mandated time, after which the mapping information stored in the mobile can be purged, such as the old IP address and old PLMN for example.

This ability to resolve IP addresses allows the present invention to correctly forward data packets between networks to an anonymous caller, providing callback access across the networks. The E-PDN can be combined in an Emergency HLR or could be part of the GGSN or equivalent in the CDMA-1X communication system. However, it should be recognized that the present invention has application in other systems, including GSM and CDMA systems, given the appropriately formatted MS identity assignments. The present invention provides particular application in allocating IP addresses from the E-PDN block when the mobile station subscriber does not have an identity (i.e. no SIM, R-UIM, USIM, no phone number, and lack of a roaming agreement between PLMNs). However, the present invention can also be used even where a mobile station includes an identity (i.e. SIM, R-UIM, USIM, phone number, and roaming agreement between PLMNs.)

Inasmuch as the mobile station does not have a subscriber identity in the application of the present invention, any assigned IP address must be matched to a particular user device. This is accomplished through the use of a unique International Mobile Equipment Identity (IMEI) code contained within the mobile unit itself, which includes could be the unit's serial number. In application, an emergency International Mobile Subscriber Identity (IMSI) is used as the mobile station (MS) identity in a GPRS attach procedure when the MS does not have a SIM. This Emergency IMSI consists of a unique pair of Mobile Country Code (MCC) and Mobile Network Code (MNC) as well as a set of pseudo-random bits containing a portion of the International Mobile Equipment Identity (IMEI). Note that the MCC number 901 and MNC number 08 can be used in the Emergency IMSI, in accordance with recommended procedures. The E-PDN then associates or maps the assigned IP address to the unit's IMSI or IMEI.

The Emergency IMSI would then be used to perform an Emergency GPRS Attach procedure in the packet-switched domain. The network operator would have full control over whether or not to enable this special emergency calling service, which is applicable in countries in which regulators require that a SIM card be used for emergency calls. The mobile user equipment would be granted a “special Emergency GPRS attach” of sorts, which would enable the mobile station to activate a special emergency signaling Packet Data Protocol (PDP) context. The emergency signaling PDP context would then be used for initiation of an emergency call in an Internet messaging (IM) system. In this case the mobile equipment would obtain an IP address for the emergency call from the E-PDN as part of the emergency signaling PDP context activation procedure. If the emergency call is to be placed via the Internet messaging subsystem, a Public User Identity in the format “user@host” can also be obtained for addressing. This Public User Identity would have the user part based on the Special Emergency IMSI and a predefined reserved domain name for the host's part indicating that this is an emergency call without a SIM.

The ECC could utilize the IP address information (or Public User Identity) to optionally filter out multiple false emergency calls being made by the same mobile without a SIM or with the SIM in order to prevent denial of service type attacks on the ECC. Moreover, the ECC could utilize the IP address information (or Public User Identity) to callback the mobile device if the call is dropped to confirm the legitimacy of the emergency.

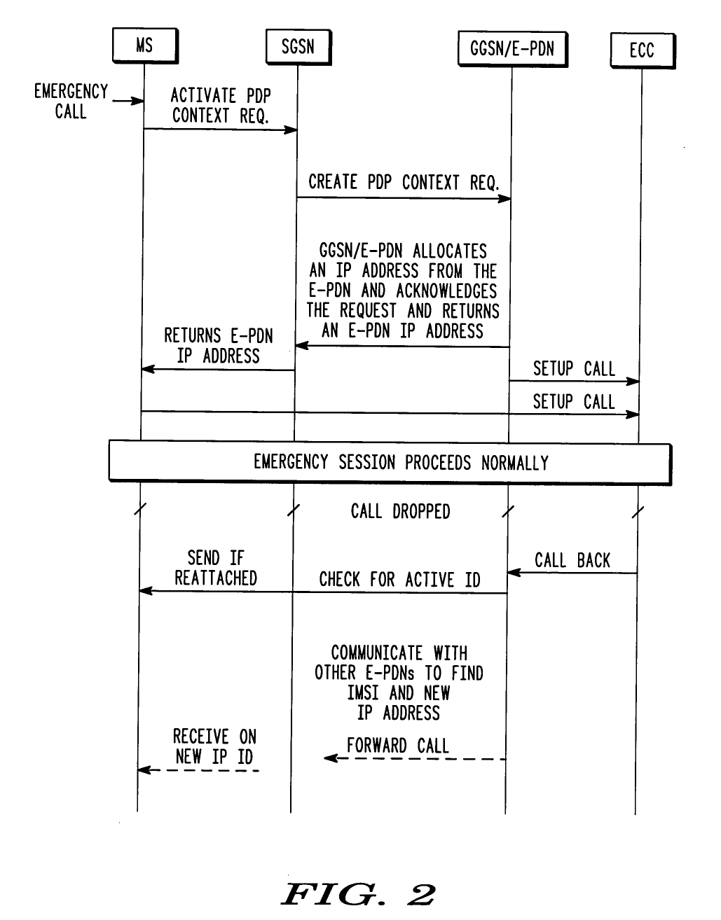

Referring to FIGS. 1 and 2, an example will be shown below where a mobile station needs to make an emergency call. It is assumed that the mobile station has no identity, such as a SIM card or even a phone number. The mobile station 12 initiates the packet data emergency call by attaching to a UMTS Terrestrial Radio Access Network (UTRAN) 22, and activating a PDP context request with the SGSN 21. The MS initiates the GPRS attach procedure by the transmission of an Attach Request message to the SGSN 21. If the MS is unidentified in the SGSN, the SGSN sends an Identity Request (Identity Type=Emergency IMSI) to the MS. The MS responds with Identity Response (Emergency IMSI). An alternative is for the MS to include the Emergency IMIS whenever it begins to initiate the emergency call.

The mobile user device includes an interim identity generator for generating the interim International Mobile Subscriber Identity (IMSI), and a SIM detector for detecting the presence of a SIM card within the user device. The user device also includes a memory for storing local information, such as local information containing an international mobile equipment identity (IMEI) corresponding to the user device, local information including an electronic serial number of the user device, local information also containing the IMSI (or IMSI=serial number), and interim or emergency IP address information received from the E-PDN.

The SIM detector detects the presence of SIM card within the user device, and informs the interim identity generator when the SIM card is not positioned within the user device. As a result, according to the present invention, when the SIM card is not inserted within the user device, the interim identity generator generates an interim International Mobile Subscriber Identity (IMSI), which is then available to a radio interface layer signaling stack of the user device in the absence of the SIM card. This generated interim IMSI would then be used to perform an anonymous IMSI GPRS attach procedure in the packet-switched domain, as described above. An operator of a radio access network would have full control over whether or not to enable the anonymous calling procedure, such as for emergency calling service for example, and which is applicable in countries in which regulators require that SIM card be used for emergency calls. Optionally, the mobile user device can be granted a special anonymous GPRS attach of sorts, which would enable mobile user device to receive data calls as well.

The generated interim IMSI of the present invention would conform to the length characteristics of a known IMSI, and is therefore up to fifteen digits in length and is encoded as a series of four-bit quantities. For example, the interim identity generator can generate an interim IMSI that includes an interim mobile country code (MCC), and an interim mobile network code (MNC), along with a set of pseudo-random digits. According to the present invention, the interim mobile country code and interim mobile network code correspond respectively to a predetermined unused mobile country code and a predetermined unused mobile network code. The pseudo-random digits contain, for example, a portion of the international mobile equipment identity (IMEI) associated with mobile user device, and in this manner the call could be traced to an equipment owner.

Upon receipt of the interim or emergency identity (IMSI), the SGSN 21 establishes a PDP context for the mobile station 12 with the GGSN 19 including the interim or emergency identity. The GGSNs acknowledges the PDP Context, and the Emergency Packet Data Network, residing in the GGSN in this example, acknowledges the emergency identity, and allocates an IP address from a predetermined list therein and maps it to the emergency identity. The E-PDN then stores this mapped IP address/identity. Optionally, the E-PDN returns the IP address associated with the interim identity to the user device 12 for storage therein.

The emergency call can then be setup between the GGSN/E-PDN and an Emergency Call Center using the IP address. Optionally, the MS can setup the call directly using the newly obtained IP address as its own. The call is completed normally through the network to the emergency call center (e.g. though a public switched telephone network) using known procedures for the GPRS/UMTS system with the assigned IP address for the MS. At this point, the emergency call session proceeds normally.

In detail, the user device 12 transmits packet-switched data (can be VoIP) through air interface to, and receives packet-switched data through air interface from the radio access network 22. The packet-switched data received from user device 12 is transmitted by the radio access network 22 to a Serving GPRS Support Node (SGSN) 21, which then transmits the packet-switched data to a Gateway GPRS Support Node (GGSN) 19. GGSN 19 converts the packet-switched data from a domain associated with the radio access network 22 to a domain associated with a packet data network (not shown) and transmits the converted packet-switched data to the packet data network for connection to an Emergency Call Center (ECC). Similarly, a callback using packet-switched data received from the ECC through the packet data network is converted by GGSN from the domain associated with packet data network to the domain associated with radio access network. The converted packet-switched data is then transmitted from GGSN to the radio access network through the SGSN. The radio access network then transmits the packet-switched data to mobile user device along air interface.

If the call is disconnected or dropped, and the ECC needs to callback the mobile that originally initiated the emergency call, the ECC will use the interim emergency IP address and route the call to the last known PLMN. In this case, the IP address will no longer be valid if the MS has roamed to another network (particularly with no roaming agreement therebetween), inasmuch as the MS camping on the new network and PDP initiation will get a new interim IP address from the E-PDN of that new network, or the MS could be in attached mode without the new IP address from new network.

In this case, the MS knows its emergency IMSI, and has a record of the last PLMN on which it was camped as well as the IP address it was assigned. This can be communicated to the new network and associated E-PDN. Although the new network and new E-PDN will assign a new IP address to the MS, the present invention has the advantage of providing linked communication between the E-PDNs, such that the IP address issue can be resolved. In particular, if a call is dropped, and the ECC can initiate a callback to the old network using the old IP address, the associated E-PDN can attempt to complete the call to the initiating MS. In particular, the E-PDN can check if the MS has reattached to its network by scanning its memory to see if the emergency IMSI of the MS is active and which IP address it has now been allocated. At that point, the ECC call can be forwarded to the MS on the new IP address.

However, if the MS has roamed to a new network and is camped thereon, the new network can contact the previous (original) PLMN indicated by the MS, and the associated E-PDNs can then communicate between themselves such that the original E-PDN can forward any calls addressed to the old allocated IP address to the new IP address in the new network. Alternatively, if the original E-PDN notes a callback to its old (non-active) allocated IP addresses (and has no forwarding information), the original E-PDN can poll the other E-PDNs to see if the initiating MS IMSI has registered on any other network and what new IP address it has been allocated by the associated E-PDN, wherein the callback can be forwarded.

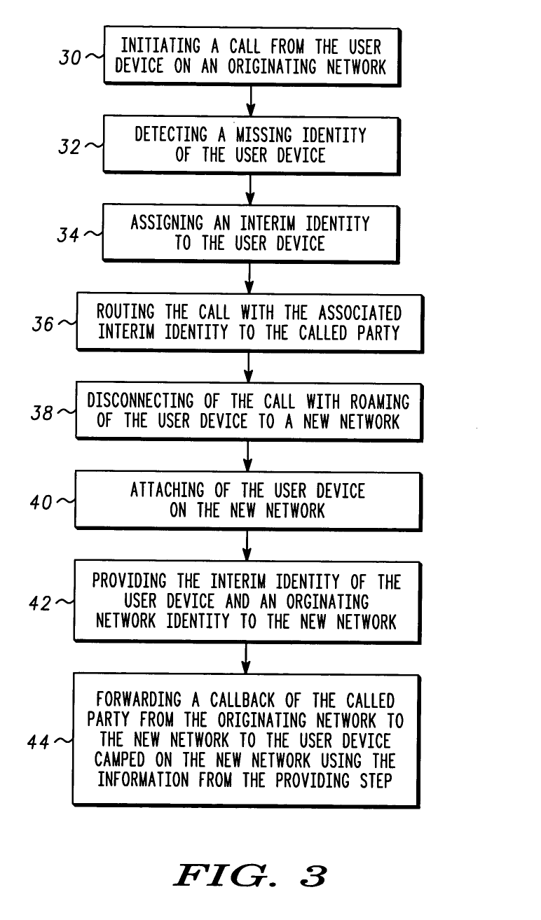

FIG. 3 is a data flow diagram for a method of providing callback from a called party to an anonymous initiating user device after a dropped call in a packet data network communication system, in accordance with the present invention. As illustrated, a first step 30 includes initiating a call from the user device on an originating network. If the user device does not have a SIM card, an interim equipment identity, such as an emergency identity (IMSI or IMEI), is generated.

A next step 32 includes detecting a missing identity of the user device by the originating network. The network determines the identity is missing and whether the particular call is an emergency and should be allowed. If the call is allowed, a next step 34 includes allocating or assigning an interim identity to the user device, such as an emergency IP address assigned by the E-PDN from a predetermined list, as explained above. The E-PDN is associated with the network and is preferably contained within a Gateway GPRS Service Node (GGSN) of the packet data network. Optionally, the emergency packet data network communicates with a GGSN of the packet data network through an emergency home location register. The interim address can also be provided to the user device for storage (along with the originating network identity). At this time, the call can be routed 36 with the associated interim identity to the called party, such the Emergency Call Center, and the call can proceed as normal.

The present invention has effect where a call is dropped and the interim address is lost (i.e. no longer linked to the user device). Therefore, a next step 38 includes disconnecting of the call with roaming of the user device to a new network. The disconnecting can be ending of the call whereafter the device roams to a new network, dropping of the call upon roaming to a new network, or a call that is ended within a FCC mandated time. The user device, if it is active, would then camp and attach 40 on the new network where it has roamed, and it would receive a new interim identity assigned by the new network upon which it is newly camped if PDP context is activated. A next step includes providing 42 the interim identity of the user device and an originating network identity to the new network. The E-PDNs is associated with each network and the originating network and new network can exchange interim identity information of the user device and network identities between themselves, and resolve the IP address issues, such as by mapping of interim identities of the user device between the originating network and the new network, for example. This can be achieved by the linking of networks, and particularly E-PDNs, to each other to share a common interim identity pool such that a user device is assigned a unique interim identity. In this way, the interim identities can be assigned, provided and coordinated by the linked emergency packet data networks. Alternatively, each network can have its own set of assignable interim identities that can be independently assigned to the user device. In addition, the exchange of identity information can be done by the user device itself, the originating E-PDN linked to the new network (and new E-PDN), or both.

Once the new and old interim IP addresses are known between networks, a next step 44 includes forwarding a callback with the old interim IP address from the called party (ECC), through the originating network, forwarded to the new network using the new address, to the user device camped on the new network. In this way, the present invention provides callback capability across networks.

As a result, the present invention enables the initiation of an anonymous emergency and callback after being dropped to a mobile device in the absence of a valid identity. Such data calls for example, occur for a third or later generation wireless mobile subscriber in the packet-switched data domains, while having minimum impact on the mobile device and network equipment, while at the same time offering a fairly wide range of access and service provision control options. Moreover, the present invention takes account of address ambiguity due to dropped calls and roaming.

The present invention uses the GPRS/UMTS as an example for detailed description. It should be obvious to those skilled in the art that the methods and apparatuses discussed are applicable or can be easily extended to other third or later generation telecommunication systems.

While the invention has been described in the context of a preferred embodiment, it will be apparent to those skilled in the art that the present invention may be modified in numerous ways and may assume many embodiments other than that specifically set out and described above. Accordingly, it is intended by the appended claims to cover all modifications of the invention which fall within the broad scope of the invention.

What is claimed is:

1. A method of providing callback from a called party to an anonymous initiating user device after a dropped call in a packet data network communication system, the method comprising the steps of:
initiating a call from the user device on an originating network;
detecting a missing identity of the user device;
assigning an interim identity to the user device;
routing the call with the associated interim identity to the called party;
disconnecting of the call, with the user device roaming to a new network;
attaching of the user device on the new network with PDP context activation;
providing the interim identity of the user device and an originating network identity to the new network; and
forwarding a callback of the called party from the originating network to the new network to the user device camped on the new network using the information from the providing step.

2. The method of claim 1, wherein the assigning step includes the substep of storing the interim identity and the originating network identity in the user device, and wherein the providing step includes the user device providing the interim identity of the user device and the originating network identity to the new network.

3. The method of claim 1, wherein the providing step includes the originating network and new network exchanging interim identity information of the user device and network identities therebetween.

4. The method of claim 1, wherein the attaching step includes a new interim identity being assigned by the new network to the user device, and wherein the providing step includes the originating network and new network resolving the interim identity of the user device and exchanging their network identities.

5. The method of claim 1, wherein the assigning step includes the substep of linking of networks to each other to share a common interim identity pool such that a user device is assigned a unique interim identity.

6. The method of claim 1, wherein the assigning step includes each network having its own set of assignable interim identities that can be independently assigned to the user device, and wherein the providing step includes a substep of mapping of interim identities of the user device between the originating network and the new network.

7. The method of claim 1, wherein the interim identities are assigned, provided and coordinated by linked emergency packet data networks, wherein each emergency packet data network is associated with each communication network.

8. A method of providing emergency callback from an emergency calling center to an anonymous initiating user device after a dropped call in a packet data network communication system, the method comprising the steps of:
initiating an emergency call from the user device having a missing identity on an originating network;
detecting a missing valid identity of the user device;
assigning an interim identity to the user device and associating the interim identity with an equipment identity of the user device;
routing the call with the associated interim identity to the emergency calling center;
disconnecting of the call, with the user device roaming to a new network;
attaching of the user device on the new network with PDP context activation, wherein a new interim identity is assigned;
providing the interim identity of the user device and an originating network identity to the new network and the new interim identity and new network identity back to the originating network; and
forwarding data packets of the emergency callback of the emergency calling center from the originating network to the new network to the user device camped thereon using the interim identities and network identities.

9. The method of claim 8, wherein the interim identities are internet protocol addresses.

10. The method of claim 8, wherein the interim identities are assigned, provided and coordinated by linked emergency packet data networks, wherein each emergency packet data network is associated with each communication network and the emergency packet data network can communicate interim identities and network identities therebetween.

11. The method of claim 10, wherein linked emergency packet data networks share a common interim identity pool such that a user device is assigned a unique interim identity.

12. The method of claim 10, wherein each emergency packet data network has its own set of assignable interim identities that can be independently assigned to the user device, and wherein the providing step includes a substep of mapping of interim identities of the user device between the originating network and the new network.

13. The method of claim 10, wherein the emergency packet data networks are contained within a Gateway GPRS Service Node (GGSN) of the packet data network.

14. The method of claim 10, wherein the emergency packet data network isolates emergency call traffic from other traffic.

15. A communication system for facilitating callback from a called party to an anonymous caller, the communication system comprising:
a user device capable of anonymously accessing a packet data network in the absence of an identity;
a packet data network operable to provide communications between the user device and the called party, the packet data network operable to detect a missing identity of the user device, and to detect a disconnected call; and
an emergency packet data network, wherein upon notification from the packet data network that a user device has no identity, the emergency packet data network is operable to assign an interim identity to the user device and route the call with the associated interim identity and an identity of the packet data network to the called party, and wherein upon notification from the packet data network that an anonymous call has been disconnected, the emergency packet data network is operable to provide the interim identity of the user device and an originating packet data network identity to the any new network where the user device is attached with active PDP context and to forward any callback of the called party from the originating network to the new network to the user device attached thereon.

16. The system of claim 15, wherein the interim identities are internet protocol addresses.

17. The system of claim 15, further comprising an emergency packet data network associated with each packet data network, wherein the emergency packet data networks are commonly-linked to communicate interim identities and packet data network identities therebetween.

18. The system of claim 17, wherein linked emergency packet data networks share a common interim identity pool such that a user device is assigned a unique interim identity.

19. The system of claim 17, wherein each emergency packet data network has its own set of assignable interim identities that can be independently assigned to the user device, and wherein the emergency packet data network maps interim identities of the user device between the originating network and the new network.

20. The system of claim 17, wherein the emergency packet data networks isolate emergency call traffic from other traffic.
